(19) United States
(12) Patent Application Publication
(10) Pub. No.: US 2008/0297883 A1
(43) Pub. Date: Dec. 4, 2008

(54) Raman Amplifier Structure

(76) Inventors: Stefano Faralli, Grosseto (IT); Gabriele Bolognini, Arezzo (IT); Giovanni Sacchi, Milano (IT); Fabrizio Di Pasquale, Pisa (IT)

Correspondence Address: COATS & BENNETT, PLLC, 1400 Crescent Green, Suite 300, Cary, NC, 27518, US

(21) Appl. No.: 11/996,354

(22) PCT Filed: Jul. 11, 2006
(86) PCT No.: PCT/EP2006/064114

§ 371 Date: Jun. 2, 2008

(30) Foreign Application Priority Data
Jul. 22, 2005 (IT) MI2005A001422

(51) Int. Cl. H01S 3/30

(52) U.S. Cl. 359/334

(57) ABSTRACT

A Raman amplifier structure (121, 221) for optically amplifying an input optical signal comprises an optical means (22) through which the optical signal is propagated, a first pump optical source (10) for generating a first pump radiation and at least one second pump optical source (24, 27) for generating a second pump radiation. The first and second pump optical radiations are combined and propagated in optical transmission means (22) for supplying an optical amplification of the signal through the Raman effect. The first pump optical source (10) comprises a first laser source (12) for generating a radiation with relatively low noise and relatively low power and a Raman amplifier (13) for amplifying the radiation coming from the first laser source for generating the first pump radiation. The Raman amplifier (13) comprises a second laser source (14) for generating an optical radiation having relatively higher power and noise than the first laser source and the radiation coming from the second laser source is used for counter-pumping the radiation coming from the first laser source (12) for generating the first pump radiation. This limits the amount of noise transferred from the second source (14) to the first pump radiation.

This invention relates to a Raman amplifier structure for optically amplifying optical signals in an optical communication system. In particular, even if not exclusively, this invention relates to a higher-order Raman amplifier using two or more optical pumps of different wavelengths and to a source for generation of one or more optical pumps. In addition, this invention relates to Raman amplifiers for higher order co-propagating pumping to be used in optical communication systems with wavelength division multiplexing (WDM).

Technologies for extending the reach in WDM transmission systems without repeaters are attracting considerable attention because of possible reduction of the costs of the system.

In particular, the use of Raman distributed amplification was found advantageous.

Higher-order Raman pumping schemes are used for lowering the distributed amplifier equivalent optical noise figure (NF_{eq}) and increasing the pump optical power sent in fiber to the remote amplifiers (erbium-doped fibers without local pump lasers but pumped remotely sending pump radiation, for example at 1480 nm, from the reception and/or transmission earth sites). In both cases, higher-order configurations provide benefits in terms of maximum repeaterless system reach (about 2.5 dB enhancement in the 1480 nm pump power delivered to remote EDFAs and up to 3 dB improvement in the equivalent optical noise figure in case of third-order counter-pumping).

Higher-order Raman co-pumping (configuration in which pump and WDM signals travel in the same direction while co-propagating along the transmission fiber) can potentially give higher advantages than higher order Raman counter-pumping. For example, passing from first-order co-pumping to second order co-pumping, approximately 3.5 dB of span can be gained while in passing from first order counter-pumping to second order counter-pumping the maximum improvement expected is only 2 dB.

However, while the higher-order counter-pumping schemes supply real benefits in terms of improvement of span reach, the Raman higher order co-pumping—which is much more affected by the transfer of noise from the pump to the signal—can be ineffective in extending the maximum reach of the system. This is mainly due to the fact that higher order co-pumping requires very high power pump sources that, with the technologies presently available, can only be provided by the Raman fiber lasers. Although very powerful and nearly completely depolarized, these lasers are characterized by high RIN figures (approximately −110 dB/Hz for frequencies up to several tens of GHz) that can be transferred to the WDM signals degrading performance in terms of Bit Error Rate (BER). The RIN for a laser source is defined as the relationship between the optical power fluctuation and the mean optical power standardized at the 1 Hz band (the unit of measure is dB/Hz).

When co-pumping schemes are used it is important to monitor the signal power for the channels launched in the transmission fiber in order to avoid non-linear propagation effects as for example Brillouin scattering, self-modulations and crossed phase-modulations, intermediations of gain and diaphony.

Let it be assumed that without Raman co-pumping on standard SMF fiber (G.652) the maximum power allowed per channel is limited to 5 dBm/ch in order to avoid nonlinear damage of transmission. If for example 15 dB of co-propagating gain were added it would be possible to reduce the input power per channel by 15 dB and thus ensure at output the same Optical Signal Noise Rate (OSNR) and therefore further reduce the mean signal power along the transmission fiber. However, in this case the Raman co-pumping would not give any advantage in terms of maximum span reachable because to a Raman co-propagating gain of 15 dB there would be a correspond reduction in the power launched in fiber of 15 dB and hence the OSNR at the receiver would be identical with and without co-propagation Raman pumping. What it is desired to do is reduce the power per channel launched in fiber of the minimum quantity required for the purpose of keeping the effects of non-linear propagation under control in the presence of the co-propagating Raman gain. Assuming that 15 dB of co-propagating gain are added and the power per channel is reduced by 10 dB (from 5 to −5 dBm per channel) without adding any penalization in transmission, this would give 5 dB net of improvement on the OSNR outgoing to the system (and hence potentially 5 dB more span), at the same time avoiding penalties induced by the non-linear propagation effects.

Consider a co-pumping scheme of the second order in which a 1360 nm pump amplifies the pump to 1450 nm which in turn amplifies the WDM channels around 1550 nm. To obtain benefits from the higher-order co-pumping two different approaches can be followed.

With the first approach the same power per channel is kept launched in fiber as in the case of a co-pumping of the first order (for example −5 dBm as in the above example) and the co-propagating gain is increased for the signal supplied by the pumping scheme—for example from 15 dB to 18 dB—giving this way an OSNR higher by 3 dB at the system outlet. Since in the higher-order co-pumping the WDM signals are amplified well inside the transmission fiber, the mean signal power along the fiber is reduced compared to the first-order co-pumping and a higher gain can be considered without additional penalties induced by the non-linear propagation effects.

With the second approach the signal power per channel is increased (for example from −5 dBm to −2 dBm) and the same co-propagating gain is kept for the signals as in the case of the first order co-pumping (15 dB). As the mean signal power along the transmission fiber with high order pumping schemes is reduced, nonlinear propagation effects with 3 dB of improvement in the outlet OSNR can be avoided.

Similar considerations can be made for a third-order or nth order co-pumping in general with additional dBs of improvement in the OSNR and resulting improvement in the reach of the system.

In general, for the high-order Raman pumping to be either co-propagating or counter-propagating or particularly efficient, high powers are required for the pumps of higher order and low powers for those of low orders (for example the required power at 1360 nm can be more than a Watt while that required at 1450 nm of a few tenths of a mW).

It has been shown experimentally that the known co-propagating pumping schemes of the second order that use Raman fiber laser as the second order pump are affected by transmission penalties that frustrate all the advantages on the OSNR given by the co-pumping of the second order as compared with the first order co-pumping.

Indeed, think of a known WDM transmission system using a 2-way Raman pumping. In particular, in order to show the characteristics of the co-propagating pumping, a fixed first-order counter-propagating pumping scheme is used obtained by means of a 1450 nm Fiber Raman Laser (FRL) and a co-pumping scheme that can be of the first or second order.

While the first order co-pumping is obtained merely by multiplexing in polarization of two high-power 1450 nm Fabry-Perot (FP) lasers the second-order scheme uses a high-power 1360 nm FRL to amplify a 1450 nm seed (supplied by a depolarized laser diode or by two polarization multiplexed laser diodes) which in turn amplifies the WDM channels around 1550 nm and are propagated in the same direction as the pumps that co-propagate along the transmission fiber.

Comparison of the OSNR performance supplied by said known co-pumping schemes whether first or second order, with optimized and fixed counter-pumping, indicates a considerable improvement in the OSNR in case of second-order co-propagating pumping. Although this improvement in the OSNR could lead in principle to an extended span reach, in practice no appreciable improvement in the BER performance is observed because of transfer of the RIN between pump and signal. In particular, the reason for this is that the 1360 nm FRL transfers its high RIN to the WDM signals over the 1450 nm seed.

Experimental measures have clearly shown these effects, showing considerable penalties in the Q-factor not present in the conventional first order co-pumping schemes using low-RIN laser diodes multiplexed in 1450 nm polarization. The theoretical calculations based on RIN transfer modes confirm the considerable penalizations of the Q-factor in case of second-order co-pumping with the conventional pump sources.

Availability of high-power low-RIN pump sources is therefore to be desired. Among other things, availability of similar sources would allow realizing structures with higher-order co-pumping effectiveness giving great OSNR improvements without any transmissive penalty. This would lead directly to significant improvements in the span reach in a repeaterless WDM transmission system.

Unfortunately, in the prior art of optical systems, feasible solutions have not been proposed yet for having Raman structures with suitable pump sources with real high power and low RIN.

The general purpose of this invention is to remedy the above mentioned shortcomings by making available an innovative Raman amplifier with high-power low-RIN pump optical source so as to be able to realize an effective pumping even of high order and allow among other things realizing optical transmission systems with increased repeaterless span length.

In view of this purpose it was sought to provide in accordance with this invention a Raman amplifier structure for optically amplifying an input optical signal and comprising an optical means through which the optical signal is propagated, a first pump optical source for generating a first pump radiation having a first wavelength, and at least one second pump optical source for generating a second pump radiation having a second wavelength with said first and second pump optical radiations being combined for propagating in said optical means for supplying an optical amplification of the signal through the Raman effect and characterized in that the first pump optical source comprises a first laser source for generating a radiation with relatively low noise and relatively low power at said first wavelength with a Raman amplifier for amplifying the radiation coming from the first laser source for generating said first pump radiation and in which the Raman amplifier comprises a second laser source for generating an optical radiation having relatively more higher power and noise than the first laser source and in which radiation coming from the second laser source is used for counter-pumping the radiation coming from the first laser source for generating said first pump radiation so as to limit thereby the amount of noise transferred from the second source to the first pump radiation.

To clarify the explanation of the innovative principles of this invention and its advantages compared with the prior art there is described below with the aid of the annexed drawings a possible embodiment thereof by way of non-limiting example applying said principles. In the drawings:

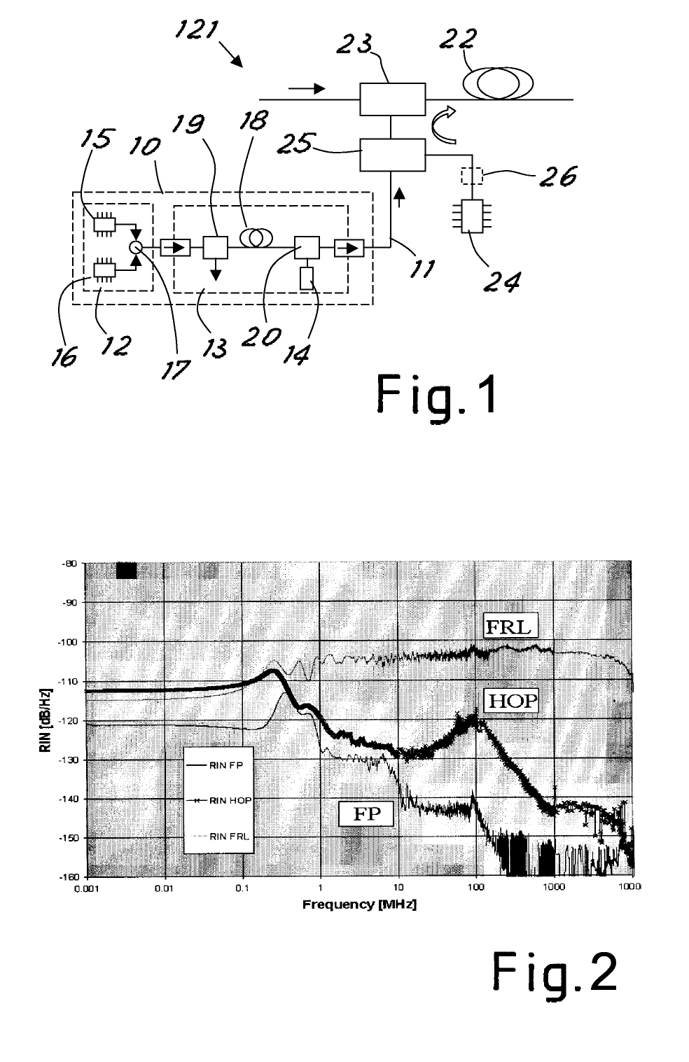

FIG. 1 shows schematically a second order co-pumped distributed Raman amplifier structure realized in accordance with the principles of this invention,

FIG. 2 shows a comparative graph of the spectral course of the RIN for prior art pump optical sources and for a pump optical source such as that used in an amplifier structure in accordance with this invention, and

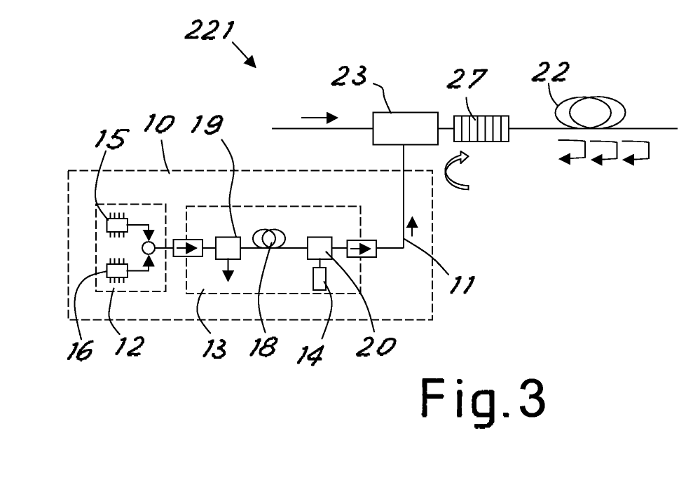

FIG. 3 shows a second second-order co-pumped distributed Raman amplifier structure realized in accordance with this invention.

With reference to the figures, FIG. 1 shows diagrammatically a first Raman amplifier structure designated as a whole by reference number 121. The structure comprises a first optical source 10 which supplies a first pump radiation with a first wavelength on an outlet 11.

The pump optical source, called here High-Order Pump (HOP) comprises in turn a first laser source 12 for generating a low-noise radiation and relatively low power at the above-mentioned first wavelength. The outlet power of said first source is increased by means of a discrete first-order Raman amplifier 13 that realizes a counter-pumping of the source 12 by using a high-power second laser source 14 and relatively more noise so as to generate the first pump radiation on the outlet 11.

Various known low power and low RIN laser sources can be used in the first source 12 even if it has been found preferable that said first source 12 comprise at least one known Fabry-Perot (FP) laser since said lasers have very low RIN. Advantageously at least one Fabry-Perot laser is stabilized using a known Bragg fiber grating.

As shown in FIG. 1, in the source 12 there are preferably included two FP lasers 15, 16 with outlets polarization multiplexed by means of a known Polarization Beam Combiner (PBC) 17 so as to ensure gain independent of the polarization. As an alternative (not shown but easily imaginable for those skilled in the art), a single FP laser can also be used in conjunction with a known depolarizer. The low RIN and low power light emitted by the source 12 is sent to the pumping span 13 for Raman amplification. The Raman amplification is produced in an appropriate optical means 18 which is preferably a block of selected length (for example 1.5 km) of fiber of the Dispersion Compensating Fiber (DCF) type. The length of the fiber will be optimized subject to the inlet power and pump power available. Other non-linear fibers or optical wave guides can also be used. In the optical means 18 the radiation coming from the second laser source 14 counter-pumps the radiation coming from the first laser source 12 to generate the first pump radiation at point 11.

The pump laser 14 of the pumping section 13 comprises preferably a Fiber Raman Laser (FRL) since said lasers are economical and give high output power although they are relatively noisy. The light of the first low RIN source is preferably counter-pumped by means of the FRL as this minimizes the amount of noise transferred to the signal.

It is known that, with counter-propagating pumping schemes, transfer of the pump RIN to the signal can take place only at low frequencies.

The wavelengths of the sources 12 and 14 at low and high power respectively will depend on the pumping order required, the type of fiber or optical guide used in the Raman amplifier, and on the spectral zones where the WDM signals are housed. In particular, in the preferred form with second-order co-propagating pumping as in FIG. 1, conventional band WDM signals (around 1550 nm) and type DCF fiber 18, the wavelengths of the sources 12 and 14 will be preferably 1360 nm and 1275 nm. The second order co-propagating pumping in transmission fiber will be obtained by combining the pump 10 at 1360 nm with the depolarized pump 24 (or 27) at 1450 nm which, when amplified in fiber by the 1360 nm radiation, will in turn amplify the signals around 1550 nm).

With WDM signals in extended band (around 1580 nm) the first and second pump optical radiation will have wavelengths of effectively 1390 nm and 1480 nm respectively.

In the first pump optical source 10, optical blocking means 19 are used advantageously to block radiations coming from the second laser source 14 and directed towards the first laser source 12. In particular, such blocking means can comprise a known wavelength selective routing device such as a wavelength division multiplexer (WDM) 19 connected to protect the low-RIN source 12 (for example the FP lasers) from the radiations extracted at the pump wavelength emitted by the source 14.

Second routing means, advantageously in the form of a second WDM 20, are advantageously used for coupling to the Raman fiber 18 the pump radiations of the source 14 so as to prevent at the same time that these pump radiations reach the outlet 11 of the HOP.

FIG. 2 shows typical RIN spectral figures measured for a high-power FRL and for a Fabry-Perot laser diode. The same graph also shows the RIN spectrum at the outlet 11 of the optical source of FIG. 1 with first low-RIN source at 1360 nm and pump source at 1275 nm.

It can be seen that the 1360 nm output laser light at amplified by the pump laser to 1275 nm has high RIN figures only at low frequencies (approximately −110 dB/Hz) with a cut-off frequency less than 1 MHz. At higher frequencies the RIN figures decrease rapidly because of the counter-pumped discreet Raman amplifier transfer function.

If the RIN spectrum of the innovative HOP source is compared with the typical RIN spectrum of a 1360 nm FRL, which could be used as a second-order pump, it is clear that the source in accordance with this invention has a much lower RIN level with frequency over 100 kHz. Considering that this pump source will be used for higher order co-pumping, with a transfer function characterized by cut-off frequencies several MHz higher in the case of standard SMF fibers and even higher for NZ-DS fibers, a transfer to the WDM signals of a much lower RIN in the case of 1360 nm HOP compared with the use of a 1360 nm FRL is to be expected. It is to be noted that using a truly high-power FRL (for example 1275 nm) as source 14, the discreet Raman amplifier used in the pump 10 can supply up to 1.5-2 W at the output 11 at the desired wavelength (for example 1360 nm) starting from only a few hundred mW of power at the inlet of the amplifier 13.

The optical source with the discreet Raman amplifier shown in FIG. 1 can therefore supply pump light characterized at the same time by high power and low RIN levels as required for penalty-free higher order co-pumping.

Higher order co-pumping schemes based on the HOP optical source can easily supply several dB of improvement in the repeater-less WDM transmission systems reach.

In the structure of FIG. 1 there is an optical means 22 (in general a transmission fiber, for example a standard SMF) through which the input signal is propagated. This signal contains in general the WDM channels that are amplified by second-order co-pumping thanks to the amplifier structure in accordance with this invention.

To achieve this, the structure comprises a second pump source 24 that generates a second pump radiation with a second wavelength. Advantageously, the first wavelength is shorter than the second and in particular the first wavelength can be shorter than the second wavelength by an amount effectively corresponding to a frequency deviation of a Stokes parameter induced by the optical means 22. In this particular case there is a 1360 nm pump light produced by the optical source 10 and a 1450 nm pump light produced by the second source 24.

The first and second pump radiations are combined to propagate in the optical means 22 and supply optical amplification of the signal through the Raman effect.

Advantageously, the first and second pump optical radiations are co-propagated with the input optical signal. To combine the two sources with each other and with the optical signal input to the structure, a first WDM 25 receiving the radiations of the two optical sources 10 and 24 is advantageously used and it sends them combined to a second WDM 23 that combines them with the inlet signals to be amplified.

The source 24 can be chosen to generate the second pump radiation with relatively low noise and power compared with the first pump radiation.

Advantageously, the source 24 used for this purpose is a 1450 nm Fabry-Perot laser. If necessary a depolarizer 26 can be added after the laser 24. Alternatively the source 24 can be obtained by multiplexing two 1450 nm Fabry-Perot lasers.

Such a structure in accordance with this invention allows obtaining a considerable improvement in the performance of the transmission system with a considerable increase in reach without repeaters compared with the prior art solutions where, for example, in place of the optical source 10 there is a normal 1360 nm fiber Raman laser (FRL).

FIG. 3 shows another Raman pumping distributed amplification structure realized again according to the principles of this invention and designated as a whole by reference number 221.

In this structure 221 the light generated by the first optical source 10 is not combined with the light of a second optical source realized with an FP laser as in the realization of FIG. 1 but is directly inserted in the optical means 22 by means of the WDM 23.

The second pump optical source comprises a wavelength selective reflection structure 27 placed between the optical path of the input optical signal to reflect the radiation generated in the optical means that has wavelength corresponding effectively to the second pump wavelength.

In particular, the wavelength selective reflection structure can advantageously comprise at least one known Fiber Brag Grating (FBG) defined in the optical means 22. With the light of the first 1360 nm source the Bragg fiber grating 27 is 1450 nm.

The grating thus supplies the seed for higher-order pumping. Indeed, the higher order 1360 nm pump generates light for amplified spontaneous emission around 1450 nm and the presence of the 1450 nm FBG with Rayleigh scattering distributed along the transmission fiber generates in turn 1450 nm lasing that acts as a pump for the WDM signals around 1550 nm.

1450 nm lasing generation using this solution can be expedient compared with use of a 1450 nm seed (depolarized Fabry-Perot laser) as shown in FIG. 1. This is mainly due to the fact that the 1450 nm lasing generated by the FBG and by the distributed Rayleigh scattering propagates in both directions along the fiber 22 with resulting reduction of noise transfer to the 1550 nm WDM signal. Only the 1450 nm co-propagating light with the WDM signal will transfer noise.

It is now clear that the preset purposes have been achieved by making available a high-power low-RIN optical source allowing obtaining various pump structures for Raman amplification with high quality characteristics and consequently high reach in repeaterless transmission systems.

Naturally the above description of an embodiment applying the innovative principles of this invention is given by way of non-limiting example of said principles within the scope of the exclusive right claimed here.

Various types of sources with sufficiently low RIN and low power can be used as source 12 to by amplified depending also on which RIN and power characteristics it is desired to obtain as optical source output. For example, the actual choice can also depend on the reach believed sufficient to obtain in the transmission system. For example, if considered sufficient, known Fabry-Perot lasers stabilized by Bragg fiber gratings might also be used although these lasers could lead to a higher-RIN signal.

In the embodiments described the amplifier structure is in a co-pumped arrangement. As now readily imaginable to those skilled in the art, the principles of this invention can also be use to realize a Raman amplifier with a counter-pumped arrangement even if in such a configuration the advantages are not as important as in the co-pumped arrangement.

The structures shown in the figures are aimed at having an effective second order co-pumping. On the basis of the descriptions made above, it is clear to one skilled in the art how the principles of this invention can be readily extended to co-pumping schemes of the third order or more which therefore fall again within the scope of this invention. The source 10 can be used also for first-order pumping. By way of example, low RIN characteristics transferred to the WDM signals thanks to a pumping scheme with the proposed HOP are detectable even considering a first-order co-pumping transmission.

The idea can clearly be extended to various orders of pumping schemes operating with WDM signals located in different bands, for example S band centered around 1490 nm, C band centered around 1550 nm and L band centered around 1580 nm.

1-22. (canceled)

23. A Raman amplifier structure for optically amplifying an input optical signal comprising:
a first optical waveguide to propagate an optical signal;
a first pump optical source configured to generate a first pump radiation having a first wavelength;
a second pump optical source configured to generate a second pump radiation having a second wavelength, wherein the first and second pump optical radiations are combined to propagate through the first optical waveguide to optically amplify the optical signal; and
the first pump optical source comprising:
a first laser source configured to generate low noise, low power optical radiation at the first wavelength; and
a Raman amplifier configured to amplify the low noise, low power optical radiation to produce the first pump radiation, the Raman amplifier including a second laser source configured to generate an optical radiation having a power level and a noise level that is higher than the first laser source, and wherein the optical radiation is used in counter-pumping the low noise, low power optical radiation generated by the first laser source so as to limit the amount of noise transferred from the second laser source to the first pump radiation.

24. The amplifier structure of claim 23 wherein the first wavelength is shorter than the second wavelength.

25. The amplifier structure of claim 23 wherein the first wavelength is shorter than the second wavelength by an amount effectively corresponding to a frequency shift of a Stokes parameter induced by the first optical waveguide.

26. The amplifier structure of claim 23 wherein the first laser source comprises at least two lasers and a polarization combiner that is configured to combine outputs of the at least two lasers in polarization.

27. The amplifier structure of claim 23 wherein the first laser source comprises at least one Fabry-Perot laser.

28. The amplifier structure of claim 27 wherein the at least one Fabry-Perot laser is stabilized using Bragg fiber grating.

29. The amplifier structure of claim 23 wherein the second laser source comprises a Raman fiber laser.

30. The amplifier structure of claim 23 wherein the Raman amplifier further comprises a second optical waveguide configured to receive radiation generated by the second laser source, and wherein the radiation generated by the second laser source is used to counter-pump the radiation generated by the first laser source to generate the first pump radiation.

31. The amplifier structure of claim 30 wherein the second optical waveguide comprises an optical fiber.

32. The amplifier structure of claim 31 wherein the optical fiber comprises a chromatic dispersion compensating type optical fiber.

33. The amplifier structure of claim 23 wherein the first pump optical source comprises an optical blocking mechanism configured to block the radiation output by the second laser source from propagating to the first laser source.

34. The amplifier structure of claim 33 wherein the optical blocking mechanism comprises a wavelength selective routing device.

35. The amplifier structure of claim 23 further comprising a wavelength division multiplexer configured to:
couple the radiation generated by the second laser source in a second optical waveguide; and
prevent the radiation generated by the second laser source from arriving at an output of the first pump optical source.

36. The amplifier structure of claim 23 wherein the radiation generated by the first and second pump optical sources are co-propagated with the input optical signal.

37. The amplifier structure of claim 23 wherein the second pump optical source comprises a laser configured to generate the second pump radiation to have a noise level and a power level that is lower than the first pump radiation.

38. The amplifier structure of claim 37 wherein the second pump optical source comprises a Fabry-Perot laser.

39. The amplifier structure of claim 37 further comprising a depolarizer configured to depolarize the second pump radiation prior to the second pump radiation being combined with the first pump radiation and the optical signal.

40. The amplifier structure of claim 23 wherein the second pump optical source comprises a wavelength selective reflection structure within an optical path of an input optical signal, wherein the wavelength selective reflection structure is configured to reflect radiation generated in the first optical waveguide having a wavelength that substantially corresponds to the second pump wavelength.

41. The amplifier structure of claim 40 wherein the wavelength selective reflection structure comprises at least one Bragg grating defined in the first optical waveguide.

42. The amplifier structure of claim 40 wherein the input optical signal comprises wavelength division multiplexed radiations having a wavelength of about 1550 nm, and wherein the first and second pump radiations have wavelengths of about 1360 nm and 1450 nm, respectively.

43. The amplifier structure of claim 42 wherein the first laser source is configured to generate radiation having a wavelength of about 1360 nm, and wherein the second laser source is configured to generate radiation having a wavelength of about 1275 nm.

44. The amplifier structure of claim 40 wherein the input optical signal comprises wavelength division multiplexed radiation having a wavelength of about 1580 nm, and wherein the first and second pump optical radiations have wavelengths of about 1390 nm and 1480 nm, respectively.
